(19) United States
(12) Patent Application Publication
(10) Pub. No.: US 2013/0158725 A1
(43) Pub. Date: Jun. 20, 2013

(54) ADAPTIVE STOCHASTIC CONTROLLER FOR DISTRIBUTED ELECTRICAL ENERGY STORAGE MANAGEMENT

(71) Applicants: Roger N. Anderson, New York, NY (US); Albert Boulanger, New York, NY (US); Arthur A. Kressner, Westfield, NJ (US)

(72) Inventors: Roger N. Anderson, New York, NY (US); Albert Boulanger, New York, NY (US); Arthur A. Kressner, Westfield, NJ (US)

(21) Appl. No.: 13/589,916

(22) Filed: Aug. 20, 2012

Related U.S. Application Data
(63) Continuation of application No. PCT/US2011/026065, filed on Feb. 24, 2011.
(60) Provisional application No. 61/307,795, filed on Feb. 24, 2010.

(51) Int. Cl. G05F 5/00

(52) U.S. Cl. CPC G05F 5/00
USPC 700/286

(57) ABSTRACT

A system for managing a battery in communication with an electrical grid that includes (a) a data collector to collect data representative of an electrical grid; (b) an ASC controller operatively coupled to the data collector and adapted to receive collected data therefrom, the ASC controller comprising a financial strategizer to send instructions based on the collected data; and (c) a battery controller operatively coupled to the ASC controller to receive the instructions transmitted by the ASC controller, the battery controller configured to dictate whether the battery receives electricity from, or transmits electricity to the electrical grid.

This application is a continuation of International Patent Application Serial No. PCT/US2011/026065 filed Feb. 24, 2011 and claims priority to U.S. Provisional Application Ser. No. 61/307,795 filed on Feb. 24, 2010, the contents of both of which are hereby incorporated by reference in their entireties herein.

### FIELD

The presently disclosed subject matter relates to systems and methods for improved decision making regarding whether a resource should be stored, not stored or otherwise consumed or distributed.

### BACKGROUND

There has been, and will continue to be, a wider acceptance of electrical vehicles and other batteries that can both transmit electricity to, and receive electricity from an electrical grid. Furthermore, companies are beginning to convert their fleets to electrical vehicles. Accordingly, large savings can be obtained from efficient management of the charging of the electrical vehicles. Thus, there remains a need to efficiently manage batteries in communication with an electrical grid.

### SUMMARY

One aspect of the presently disclosed subject matter provides a system for managing a battery in communication with an electrical grid that includes (a) a data collector to collect data representative of an electrical grid; (b) an ASC controller operatively coupled to the data collector and adapted to receive collected data therefrom, the ASC controller comprising a financial strategizer to send instructions based on the collected data; and (c) a battery controller operatively coupled to the ASC controller to receive the instructions transmitted by the ASC controller, the battery controller configured to dictate whether the battery receives electricity from, or transmits electricity to the electrical grid.

Another aspect of the presently disclosed subject matter provides a method for managing a battery in communication with an electric grid including (a) collecting data representative of an electrical grid; (b) sending data representative of the electrical grid to an ASC controller, the ASC controller comprising a financial strategizer; and (c) transmitting instructions from the ASC controller to a battery controller configured to dictate whether the battery receives electricity from, or transmits electricity to the electrical grid.

### BRIEF DESCRIPTION OF THE DRAWINGS

Further features of the presently disclosed subject matter, its nature, and various advantages will be more apparent from the following detailed description of the preferred embodiments and the accompanying drawings, wherein like reference characters represent like elements throughout, and in which:

FIG. 1 is an overview of the architecture of a system according to a non-limiting, exemplary embodiment of the presently disclosed subject matter.

FIG. 2A-B is a chart of option techniques, including switching option techniques, that can be employed in the systems and methods of the presently disclosed subject matter.

### DETAILED DESCRIPTION

The presently disclosed subject matter provides methods and systems that provide improved decision making regarding whether a resource should be stored, not stored or otherwise consumed/distributed based on at least a) real-time and/or option pricing information and b) data collected and/or analyzed based on the production of the resource. The real-time and/or option pricing information and data collected and/or analyzed based on the production of the resource can be input to a controller (e.g. an Adaptive Stochastic Controller or ASC), which assists in allocating the resource.

One aspect of the presently disclosed subject matter provides a system for managing a battery in communication with an electrical grid that includes (a) a data collector to collect data representative of an electrical grid; (b) an ASC controller operatively coupled to the data collector and adapted to receive collected data therefrom, the ASC controller comprising a financial strategizer to send instructions based on the collected data; and (c) a battery controller operatively coupled to the ASC controller to receive the instructions transmitted by the ASC controller, the battery controller configured to dictate whether the battery receives electricity from, or transmits electricity to the electrical grid.

In one embodiment, the data representative of the electrical grid includes electricity price and load data. In addition the data representative of the electrical grid can further include weather and sunlight forecast data. The data collector can be adapted to collect data representative of the battery.

In one embodiment, the ASC controller can be adapted to employ adaptive dynamic programming. For example, the adaptive dynamic programming comprises reinforcement learning.

The system of claim can further include a data warehouse, operatively coupled to the data collector and ASC controller, to store data from the data collector and actions taken by the ASC controller in response to the data from the data collector. The data warehouse can be adapted for communication with a machine learning system. The financial strategizer can be adapted to output real time options that include the option value of arbitrage and the option value of peak shaving. The battery can be associated, for example, with an electrical vehicle, or the batter can be a hybrid flow battery.

Another aspect of the presently disclosed subject matter provides a method for managing a battery in communication with an electric grid including (a) collecting data representative of an electrical grid; (b) sending data representative of the electrical grid to an ASC controller, the ASC controller comprising a financial strategizer; and (c) transmitting instructions from the ASC controller to a battery controller configured to dictate whether the battery receives electricity from, or transmits electricity to the electrical grid.

In one embodiment, an energy storage system is provided that includes an infrastructure data collector, a financial strategizer, a controller and an energy storage medium in which the controller is in communication with the infrastructure data collector and the financial strategizer to determine whether energy should be sent to the energy storage medium. The data collector can collect and/or analyze one or more of, for example, photovoltaic performance data, real-time load data, electricity price, weather forecast data and sunlight forecast data.

In the past, the use of Distributed Electric Energy Storage (DEES) for the real time support and improvement of the electric transmission and distribution (T&D) system has generally been limited to hydropower (e.g., pumped hydro), primarily due to a lack of cost-effective options and/or sufficient value bases, as well as actual field experience. Recent developments in advanced energy storage technology are providing new opportunities to use energy storage in grid stabilization, grid operation support, distribution power quality, and load shifting applications.

An example application is the battery controller for a batteries used for Fully Electrical and Electrical Hybrid Vehicles (collectively referred to herein as EV's). Batteries for EV's are mobile sinks for power during the day (when in use) and fixed sinks at night. ASC management of EV charging is most helpful during the day in large urban areas, when large populations of EV's will plug into the grid upon arrival at work, just as the electricity consumption is ramping up towards peak loads and electric transportation systems such as subways are in their morning rush hours. A further homeland security requirement can be that each EV must receive at least a partial recharge so all vehicles can make it out of the city in case of an emergency. Thus, load transfer to storage facilities linked to EV charging stations is needed in addition to grid charging to manage such variable demand.

“Green Garages” are beginning to appear in cities like New York. They certify that the power used to charge EV's comes from renewable energy sources, often, for example, from solar power obtained from solar panels mounted on roofs or other external structures in close proximity to where the power is consumed.

Also, EV's could represent a significant mobile source of emergency power in case of crisis situations such as blackouts. These Vehicle to Grid technologies (V2G) can provide additional power particularly to nearby homes. Furthermore, many countries are promoting EV use that will drive market penetration, such as the introduction of laws like “The Electric Drive Vehicle Deployment Act” of 2010 in the United States. Such mobile load and source complexities must be managed within the ASC.

The presently disclosed subject matter can also be used to power batteries for non-mobile applications. For example, a 10 MW sodium-sulfur (NAS) super-battery sold by ABB in an urban substation can be charged in accordance with the presently disclosed subject matter. The super-battery is capable of producing up to 10 MW for 10 hours and more. Embodiments of the presently disclosed subject matter include first formulating a real options evaluation method using approximate dynamic programming (ADP, for e.g., reinforcement learning) for economic evaluation of DEES opportunities and then using the same ADP framework to control the DEES once deployed. This is premised on the treatment of option valuation as a stochastic control problem. This work is extended by implementing a real time controller that implements the options decisions.

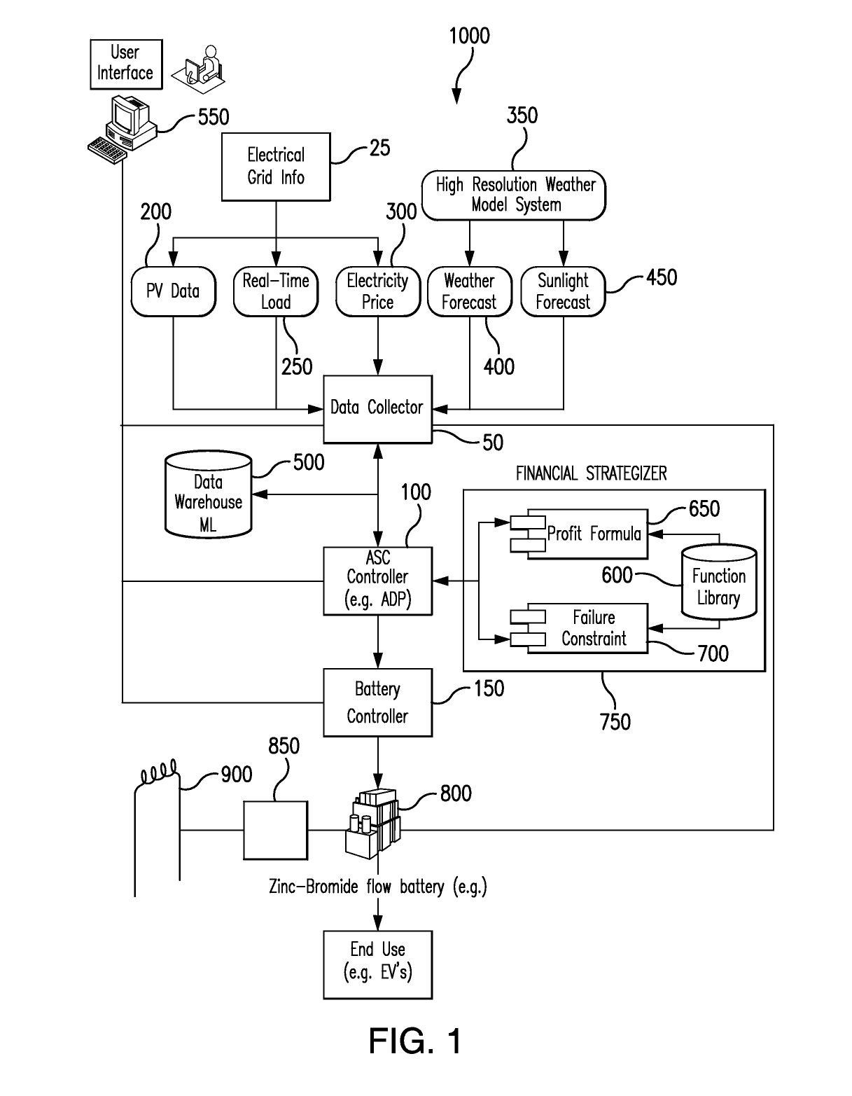

With reference to FIG. 1, one non-limiting embodiment of the presently disclosed subject matter provides a system (1000) that includes a data collector (50), a ASC Controller (100), and a battery controller (150). Each of these components is described below.

### Data Collector

The system can include a data collector to compile data obtained from an electrical grid (25). For example, and not limited thereto, the data collector can collect photovoltaic data (200) and data representative of other distributed sources (e.g., from alternative energy sources, such as wind, hydro, solar, etc.), real-time load (250) and electricity price information (300). The data, particularly electricity price, can be obtained from, for example the regional independent system operators (ISO). The price information can be used to can also be used to determine relationship between the load value and its corresponding price.

In certain embodiments, the data collector can further include inputs from a high resolution weather model system (350), which can include data representative of weather forecasts (400), sunlight forecasts (450), and other information that can influence electricity price and demand (future and present).

The data collector collects information indicative of the current valuation of electricity and communicates the information to the ASC controller (100) that can employ, for example, Approximate Dynamic Programming (ADP) discussed below. In communication with the data collector and the ASC controller's actions in response thereto is a data warehouse (500) for storing information for later analysis, e.g., via machine learning.

The data collector, which includes a processor to process the collected data, is in communication with a user interface (550). For example, the data collector can utilize load data to generate an average load curve for weekdays and weekends separately, both of which can be accessed by the user interface and transmitted to the ASC controller.

### The ASC Controller

The ASC Controller is a core module of the system. It can receive load curve and the pricing formula as input from the data collector and generate the operating policy for the super battery, so that it is able to decide when and how much the battery needs to charge/discharge the electricity for the following day. The configuration information will be sent to the Battery Controller (150) as an electrical control signal.

In certain embodiments, the ASC Controller incorporates a financial strategizer (750). For example, the financial strategizer can consist of a function library (600), which in turn can be in communication with a value formula system (650) which can contain the real option evaluation, and a failure constraint system (700) (also referred to as an Engineering Constraint) to account for engineering limitations of the system (e.g. models to account for the battery age, capacity, and recharging profile over time). Engineering information regarding the failure constraint can be obtained from vendors associated with the battery and hardware components used within the system.

### Battery Controller

With continued reference to FIG. 1, the battery controller (150) is hardware that takes the configuration information from the ASC Controller as input and automatically sets the specific configuration for the battery. The battery controller is in communication with a battery (800), which in turn is in communication with an electrical grid (900). A switchbox converter (850) is provided between the electrical grid and the battery to convert the power from AC to DC.

Aspects of the presently disclosed subject matter will allow consumers, acting alone, or in concert with a local utility, to empirically decide whether to consume, store or return electrical energy (e.g. whether to charge an EV, or have the EV serve as a source of power to be sent to the utility) to produce the highest benefits based on pre-defined selection criteria. Such benefits can be quantified in financial terms plus discussed qualitatively as they relate to the environment, providing flexibility, power security and the overall improved efficiency of the electric grid and supply infrastructure.

In one embodiment, the Adaptive Stochastic Controller can exercise real options decisions in real time based on price and market condition information fed to the controller. Real time options can include, the optional value of the arbitrage, the option value of peak shaving and the option value of greater network reliability. In a further embodiment, the presently disclosed methods and systems employ the option value of environmental benefits and credits.

Systems and methods of the presently disclosed subject provide the ability to simulate and/or model the system by using parameterized engineering models being driven by both engineering, environmental, and financial uncertainties and allowing, for example, martingale or martingale-like investment and operating predictions based thereon. For example the systems and methods of the presently disclosed subject matter allow the consumer to decide to consume, store, and return energy to the local utility.

In certain embodiments, these methods and systems employ machine learning to record previous allocation decisions, and compare them to the actual transaction made, and self-correct prediction algorithms. In one embodiment, techniques for use in the presently disclosed subject matter are disclosed, for example, in International Publication No. WO 2007/03300 and U.S. Patent Application No. 2008/0270329, which is hereby incorporated by reference.

The presently disclosed subject matter include stochastic models for the price and cost processes The system also includes the separate input and treatment of technical (e.g., engineering) risks separately within the data collector and subsequent separate processing in the ASC controller.

For example, and with reference to FIG. 1, the battery (800) is in communication with the data collector such that information about the physical state of the system can be input to the data collector. Engineering limitations include the charge status of the battery, the type of battery, the age of the battery.

The data collector can communicate with the ASC Controller to provide information regarding grid congestion, environmental factors and reliability events to predict jumps in price process and associated jump volatility. The presently disclosed systems and methods can provide operating rules to maximize value over a user-specified time frame, addressing a long standing issue in realizing the real options value in actual operation. Unlike common real option valuation methods such as binominal approaches, the present approach using approximate dynamic programming is non-parametric.

In certain embodiments, the methods and systems of the presently disclosed subject matter directs samples to the possible paths via simulation instead of first building a parametric model of the distributions. Not only economic interactions, but also engineering and environmental interactions can be incorporated and policies enacted to avoid downside outcomes, and/or increase the likelihood of a maximally profitable outcome.

In one embodiment the approximate dynamic programming with simulation approach is employed in systems that require technical design. Real options in technical designs should differ from those that treat the technical systems as “black boxes.” It is useful to distinguish between options “in” and “on” systems—between those that do and do not deal with design elements. The valuation of real options “in” and “on” systems should differ, because the specifics of the technical system can mean that the financial assumptions used to calculate option values may not apply (de Neufville 2004).

Both the baseline and the new design operating characteristics that are not market related can be simulated. Such processes will have an impact on reliability and failure rates (and associated technical risks in real options analysis). By integrating a power flow simulator within the approximate dynamic programming framework, one can combine the stochastic operating conditions of the system (non-market related) with real options valuation. Such an approach will capture both the technical as well as market uncertainties in a holistic way as well as allow improved decisions considering all aspects of the decision process. This approach can be used, for example, to provide a stochastic control framework to provide control decisions for charging the super-battery or charging EV's. This control framework integrates into same control scheme the real option valuation.

The adaptive stochastic control component uses approximate dynamic programming to improve its decisions under uncertainty. The stochastic controller uses simulations or models of the battery and its operating environment including market and power flow and learns therefrom. In addition, it can exploit the fact that real options can be implemented using stochastic control and the option value is generated for its decisions. This ensures that business processes are always executed “in-the-money” given the uncertainty involved in the processes being controlled. Another feature of the system is that it learns to adapt to more accurate information, simulations, and models as well adapting to changing externalities such as markets.

The unified reinforcement-learning algorithm can be configured to evaluate opportunities as real options. In one embodiment of the disclosed subject matter, reinforcement learning algorithm processes are employed that are configured to generate actions or decisions that are always in the money (i.e., a martingale) with respect to both financial profitability and engineering efficiency.

Financial institutions often have established policies to use options to hedge their investment portfolios against a spectrum of risk, among them interest rate risk, political risk, and market risk. Traditionally, the use of options has been limited to the finance industry (i.e., for financial instruments). The presently disclosed subject matter advantageously provides for the use of options to hedge risk in other business processes and operations. The real learning algorithm of the ASC controller can be adapted to conform to a real options framework or methodology in which opportunity selections (i.e., the actions recommended the ASC) are valued as options. Such options methodology provides decision-making flexibility in identifying profitable actions despite risks and uncertainties at each level of the subject business process controlled by ASC.

The dynamic programming technique or real learning methodology that can be used in the ASC Controller is particularly suited for tightly integrating real options valuations into, for example RL algorithm or other ADP process. In dynamic programming, a problem of real option valuations and optimization can be treated as a stochastic control problem. The problem of optimizing real option value for the stochastic processes can, for example, be formulated as the problem of maximizing the expected value of discounted cash flows (DCF). The dynamic programming technique or real learning methodology for real option valuations gives the arbitrage-free price for an action/investment option when the given stochastic processes are constrained to be always in-the-money (i.e., a “martingale”) and the risk-free rate of return is used as the DCF discount factor. Additional details can be found, for example, in U.S. Pat. No. 7,395,252, which is hereby incorporated by reference in its entirety.

As noted above, the disclosed subject matter can be implemented, for example, with adaptive Stochastic Controller (ASC) for DEES that exercises real options decisions in real time based on price and market condition information fed to the controller. The real time options can include, for example, the option value of arbitrage, the option value of peak shaving, the option value of greater network reliability, and the option value of DEES environmental benefits (including monetary incentives provided by “green credits” or other public subsidies or grants).

As would be understood by those of ordinary skill in the finance arts, the options analyzer portion of the disclosed subject matter can operate based on input data, objectively verifiable, based on, for example, the current value of the underlying asset (e.g., electricity), the decision time between when the decision is made and when the electricity is needed (or time premium), exercise price (e.g., differences in the cost of electricity throughout the day, i.e., peak shaving), and the risk-free rate of interest. The system can also operate based on inputs the characterize the volatility of the underlying asset for which the electricity is used, which in certain embodiments, is the only estimated input. Information regarding cash payouts or non-capital gains returns to holding the underlying asset, which are often directly observed in the market, or sometimes estimated from related markets, can also be input into the system. See, e.g., The Real Power of Real Options, McKinsey Quarterly, 3, 1997, which is hereby incorporated by reference in its entirety.

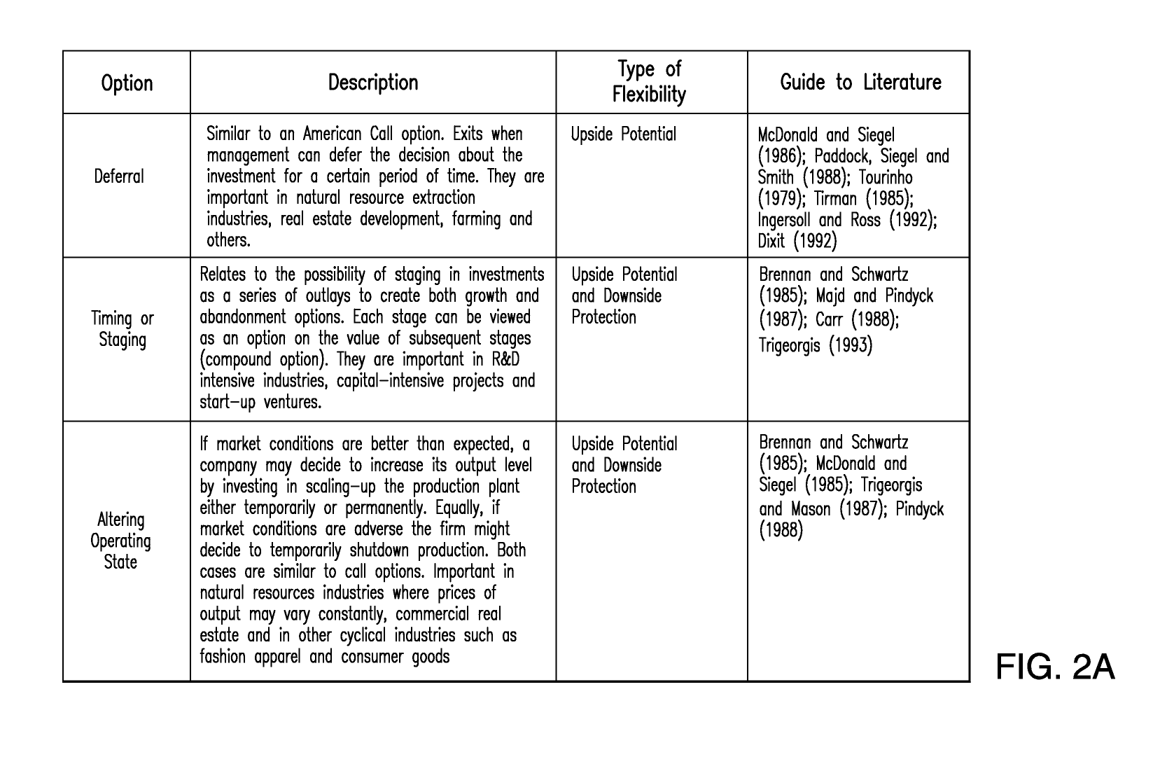

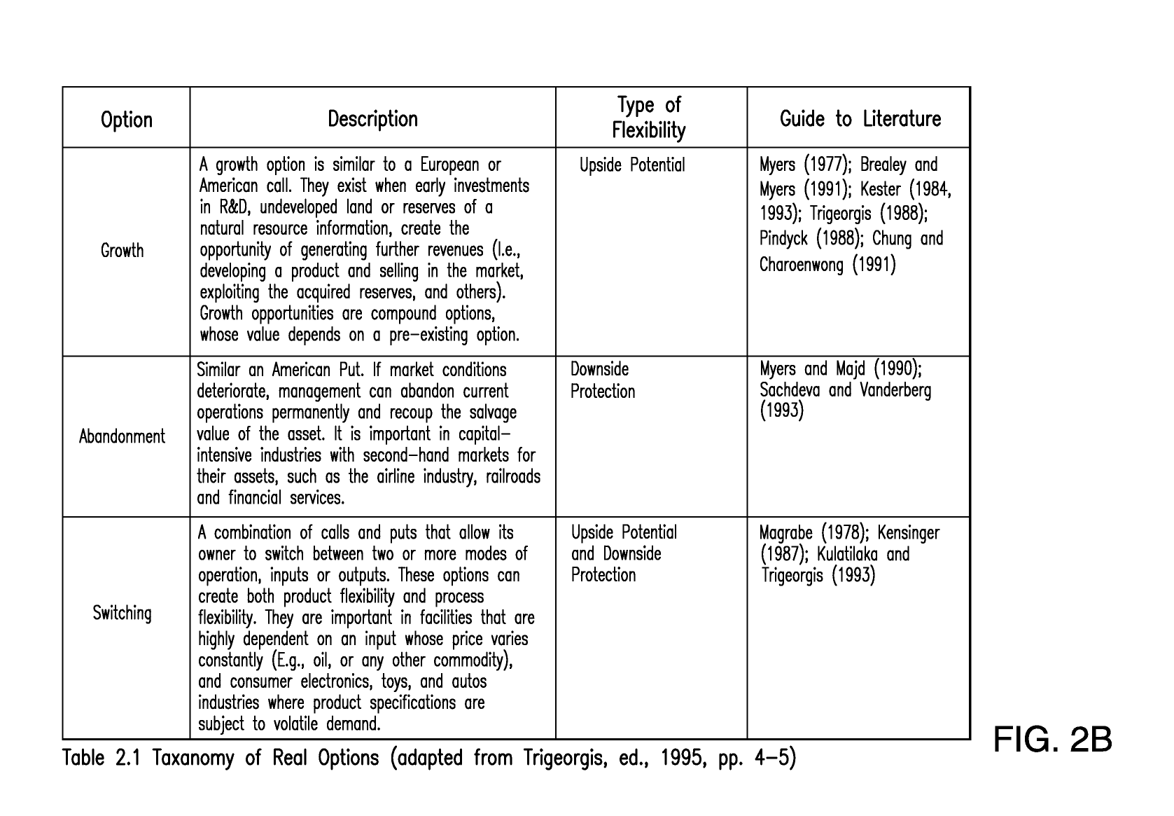

Additional information is set forth in FIG. 2. For example, switching real option methodology can be used to employ a combination of calls and puts that allow the switching between two or more modes of operation, inputs and outputs. These options can create both product flexibility and process flexibility to provide upside potential an downside protection. They are particularly important in facilities that are highly dependent on a input whose price varies constantly (e.g., oil, electricity, other commodities, consumer electronics, toys, and auto industries where product specifications are subject to volatile demand. See further Alexander Vollert, A Stochastic Control Framework for Real Options in Strategic Valuation, Birkhauser, 2002, Trigeorgis, L., ed. (1995) Real Options in Capital Investment: Models, Strategies and Applications, Praeger, Westport, Conn., and Wang, T. and de Neufville, R., Analyzing Infrastructure/Network Investments with Path-dependent Real Options, Proceedings, 8th Annual Real Options conference, Montreal, Canada, 2004.

In certain embodiments, types of information that are not used, and not required to value a real option include, one or more of: a) probability estimates, which are not needed because these are captured by the current value of the underlying asset and the volatility estimate; b) an adjustment to the discount rate for risk is not needed because the valuation solution is independent of a consumer's preference for risk; c) the expected rate of return for the underlying asset is not needed because the value of the underlying asset and the ability to form tracking portfolios already captures its risk/return tradeoff.

The presently disclosed systems and methods can include software modules running on a computer, one or more processors, or a network of interconnected processors and/or computers each having respective communication interfaces to receive and transmit data. Alternatively, the software modules can be stored on any suitable computer-readable medium, such as a hard disk, a USB flash drive, DVD-ROM, optical disk or otherwise. The processors and/or computers can communicate through TCP/IP, UDP, or any other suitable protocol. Conveniently, each module is software-implemented and stored in random-access memory of a suitable computer, e.g., a work-station computer. The software can be in the form of executable object code, obtained, e.g., by compiling from source code. Source code interpretation is not precluded. Source code can be in the form of sequence-controlled instructions as in Fortran, Pascal or “C”, for example. Hardware, such as firmware or VLSICs (very large scale integrated circuit), can communicate via a suitable connection, such as one or more buses, with one or more memory devices.

In accordance with the presently disclosed subject matter, software (i.e., instructions) for implementing the aforementioned innervated stochastic controllers and systems can be provided on computer-readable media. It will be appreciated that each of the steps (described above in accordance with this invention), and any combination of these steps, can be implemented by computer program instructions. These computer program instructions can be loaded onto a computer or other programmable apparatus to produce a machine, such that the instructions, which execute on the computer or other programmable apparatus create means for implementing the functions of the aforementioned innervated stochastic controllers and systems. These computer program instructions can also be stored in a computer-readable memory that can direct a computer or other programmable apparatus to function in a particular manner, such that the instructions stored in the computer-readable memory produce an article of manufacture including instruction means which implement the functions of the aforementioned innervated stochastic controllers and systems. The computer program instructions can also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of the aforementioned innervated stochastic controllers and systems. It will also be understood that the computer-readable media on which instructions for implementing the aforementioned innervated stochastic controllers and systems are be provided, include without limitation, firmware, microcontrollers, microprocessors, integrated circuits, ASICS, and other available media.

Various modifications and alterations to the described embodiments will be apparent to those skilled in the art in view of the teachings herein.

1. A system for managing a battery in communication with an electrical grid comprising:
(a) a data collector to collect data representative of an electrical grid;
(b) an ASC controller operatively coupled to the data collector and adapted to receive collected data therefrom, the ASC controller comprising a financial strategizer to send instructions based on the collected data; and
(c) a battery controller operatively coupled to the ASC controller to receive the instructions transmitted by the ASC controller, the battery controller configured to dictate whether the battery receives electricity from, or transmits electricity to the electrical grid.

2. The system of claim 1, wherein the data representative of the electrical grid includes electricity price and load data.

3. The system of claim 2, wherein the data representative of the electrical grid further includes weather and sunlight forecast data.

4. The system of claim 1, wherein the data collector is further adapted to collect data representative of the battery.

5. The system of claim 1, wherein the ASC controller is further adapted to employ adaptive dynamic programming.

6. The system of claim 4, wherein the adaptive dynamic programming comprises reinforcement learning.

7. The system of claim 1, further comprising a data warehouse, operatively coupled to the data collector and ASC controller, to store data from the data collector and actions taken by the ASC controller in response to the data from the data collector.

8. The system of claim 5, wherein the data warehouse is adapted for communication with a machine learning system.

9. The system of claim 1, wherein the financial strategizer is adapted to output real time options that include the option value of arbitrage and the option value of peak shaving.

10. The system of claim 1, wherein the battery is associated with an electrical vehicle.

11. The system of claim 1, wherein the battery is a hybrid flow battery.

12. A method for managing a battery in communication with an electric grid comprising
(a) collecting data representative of an electrical grid;
(b) sending data representative of the electrical grid to an ASC controller, the ASC controller comprising a financial strategizer; and
(c) transmitting instructions from the ASC controller to a battery controller configured to dictate whether the battery receives electricity from, or transmits electricity to the electrical grid.

13. The method of claim 12 wherein the data representative of the electrical grid includes electricity price and load data, and weather and sunlight forecast data.

14. The method of claim 12, wherein the ASC controller employs adaptive dynamic programming.

15. The method of claim 14, wherein the adaptive dynamic programming comprises reinforcement learning.

16. The method of claim 12, further comprising storing the collected data and the response taken by the ASC controller in response to the collected data in a data warehouse.

17. The method of claim 16, wherein the data warehouse is in communication with a machine learning system.

18. The method of claim 12, wherein the financial strategizer outputs real time options that include the option value of arbitrage and the option value of peak shaving.

19. The method of claim 12, wherein the battery is associated with an electrical vehicle.

20. The method of claim 12, wherein the battery is a hybrid flow battery.
